(19) United States
(12) Patent Application Publication
(10) Pub. No.: US 2006/0232245 A1
(43) Pub. Date: Oct. 19, 2006

(54) Protection device for a chargeable battery

(75) Inventors: Jing-Yih Cherng, Tao-Yuan (TW); Wei-Chen Wu, Tao-Yuan (TW); Chen-Chin Chang, Tao-Yuan (TW)

Correspondence Address: HDSL, 4331 STEVENS BATTLE LANE, FAIRFAX, VA, 22033, US

(73) Assignee: Amita Technologies Inc Ltd.

(21) Appl. No.: 11/106,492

(22) Filed: Apr. 15, 2005

(51) Int. Cl. H02J 7/00

(52) U.S. Cl. 320/134

(57) ABSTRACT

A protection device for a rechargeable battery connected between a main current source and a large amperage power source, the protection device includes: a first protection loop which has: a main current load and a battery (set) connected to a main circuit; and a thermocouple sensing switch connected to the battery (set) and the main circuit; a second protection loop which has: a protection circuit connected to the main circuit and checking voltage of the battery to output an activation signal; and a heater next to the thermocouple sensing switch. When the battery is in over-charged or over-discharged condition, the protection circuit outputs a control signal to turn on the semiconductor switch and the thermocouple sensing switch related to the heater.

### BACKGROUND OF THE INVENTION

The present invention relates to a protection device for a rechargeable battery, and more particularly, to a protection device that utilizes a thermocouple sensing switch, a semiconductor switch and a heater to form two protection loops. Therefore, when the battery (set) generates large currents, over-charges or over-discharges into the main circuit, the device of the present invention utilizes the two protection loops to perform a protection process. The semiconductor switch for the protection execution can be a small sized complementary metal oxide semiconductor (CMOS) switch, which is characterized by a small size, high resistance, low costs, high operating sensitivities and which is capable of simplifying the design of the protection circuit.

Conventional protection device for rechargeable batteries in 3C consumer electronic products utilizes at least one protection unit for monitoring voltage values or current values of the connected battery or batteries, and a semiconductor switch for receiving the detection result of the protection circuit to cut the charging/discharging loop when an over-charge or over-discharge situation arises. The semiconductor switch is typically a CMOS switch, which is characterized by a small size, high resistance, a low cost, and high operating sensitivities. The CMOS switch can be utilized for multiple series-parallel large amperage power source batteries, such as POWER2. This type of power source battery has a large charging/discharging amperage characteristic, and a normal current between 30˜40 amps, but a momentary maximum current of up to more than 100 amps. However, the protection circuit utilizes a CMOS switch, which must be a large size with low resistance and a high cost, which requires a more complicated circuit design, and which only has a single protection loop.

There are some other thermal circuits, such as U.S. Pat. Nos. 6,833,782, 5,576,683 and 4,533,894, and these patents disclose a protection circuit that utilizes two metals and a heater. However, these three patents disclose circuits that have large sizes and no voltage detection abilities, which may be suitable for typical electronic products, but which is not suitable for 3C consumer electronic products.

### SUMMARY OF THE INVENTION

The present invention provides a protection device for a rechargeable battery, and more particularly, a protection device that utilizes a thermocouple sensing switch, a semiconductor switch and a heater to form two protection loops. Therefore, when the battery (set) generates large currents, or enters into an over-charged or over-discharged state, the device of the present invention utilizes the two protection loops to perform the protection process. The semiconductor switch for the protection execution can be a small sized CMOS switch, which has a small size, a high resistance, a low cost, high operating sensitivities, and which enables a simplified design of the protection circuit.

Accordingly, the protection device of the present invention comprises a first protection loop having a main current load and a battery (set) connected to a main circuit; and a thermocouple sensing switch connected to the battery (set) and the main circuit; a second protection loop having a protection circuit connected to the main circuit and checking voltage of the battery to output an activation signal; and a heater next to the thermocouple sensing switch. When the battery is in over-charged or over-discharged condition, the protection circuit outputs a control signal to turn on the semiconductor switch and the thermocouple sensing switch related to the heater.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a circuit structure block drawing of an embodiment according to the present invention.

FIG. 2 is a circuit structure block drawing of a protection circuit in the embodiment according to the present invention.

FIG. 3 is a circuit structure block drawing of another embodiment according to the present invention.

FIG. 4 illustrates a normal state of the thermocouple sensing switch according to the present invention.

FIG. 5 shows the thermocouple sensing switch triggered according to the present invention.

### DETAILED DESCRIPTION OF THE INVENTION

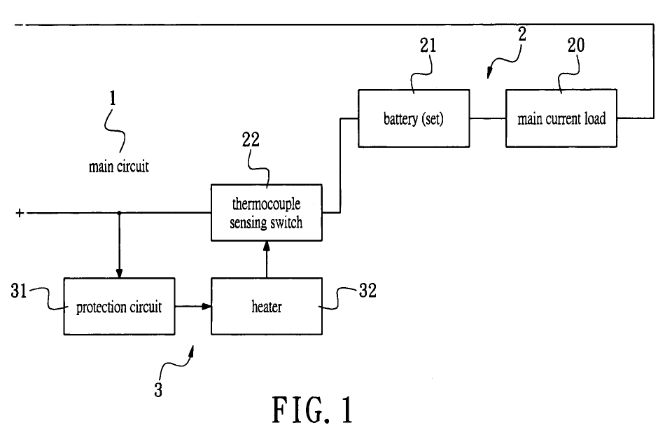

Please refer to FIG. 1. FIG. 1 is a circuit structure block drawing of an embodiment according to the present invention. As shown in the drawing, the protection device for a rechargeable battery of the present invention is used for protecting multiple series-parallel large amperage power sources. The protection device comprises at least one main current load 20 and a battery (set) 21 connected to a main circuit 1 and composed of a thermocouple sensing switch 22 to form a first protection loop 2, and a second protection loop 3 connected to the main circuit 1 and the thermocouple sensing switch 22.

The battery (set) 21 is a multiple series-parallel large amperage power source battery, such as POWER2, and is connected to the main circuit 1 and one main current load 20 to undergo charging and discharging.

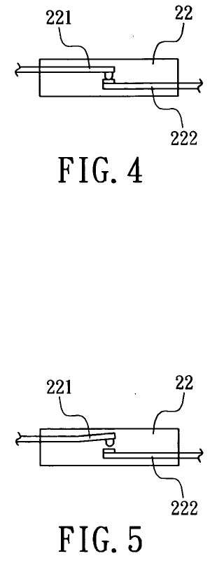

The thermocouple sensing switch 22 is a thermocouple sensing switch that further comprises two corresponding platinum sheet contacts 221, 222. As shown in FIG. 4, the thermocouple sensing switch 22 has one end connected to the main circuit 1 and the other connected to the battery (set) 21 to form the first protection loop 2. The thermocouple sensing switch 22 thus can automatically trigger when there is a large current, or when there is a high environmental temperature, to provide protection, and can automatically reset to restore power.

The second protection loop 3, as shown in FIG. 1, is composed of a protection circuit 31 and a heater 32, and is connected to the main circuit 1 and the thermocouple sensing switch 22 of the first protection loop 2. The second protection loop 3 can thus detect the battery (set) 21 when connected to the main circuit 1 via the protection circuit 31, and when the voltage or the current enters into an over-charged and over-discharged state, the second protection loop 3 outputs a protection operating signal to turn on the heater 32 to heat the thermocouple sensing switch 22 so that the thermocouple sensing switch 22 connected to the main circuit 1 will trigger for circuit protection.

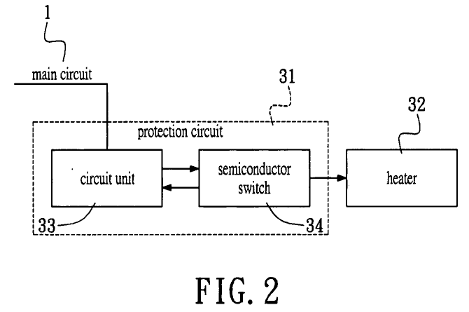

The protection circuit 31, as shown in FIG. 2, comprises a circuit unit 33 connected to the main circuit 1 for checking the voltage of the battery (set) and outputting an activation signal when an over-charged or over-discharged state is detected according to the checking result. A semiconductor switch 34 is connected between an output end of the circuit unit 33 and the heater 32 and is used for controlling the heater 32.

In the embodiment of the present invention, the semiconductor switch 34 is connected to the heater 32 and thermocouple sensing switch 22 to provide over-charged or over-discharged protection for the battery (set). The semiconductor switch 34 is a small sized CMOS switch which provides rechargeable battery protection for 3C consumer electronic products. The semiconductor switch 34 thus is characterized by a small size, a high resistance, a low cost and high operating sensitivities.

The heater 32 is used to provide heat, and in the embodiment of the present invention the heater 32 is placed next to the thermocouple sensing switch 22. When the battery (set) is over-charged or over-discharged, the protection circuit 31 detects this condition and outputs a signal to switch on the semiconductor switch 34 to cause the heater 32 to heat the thermocouple sensing switch 22. The thermocouple sensing switch 22 of the main circuit 1 will thus trigger for circuit protection.

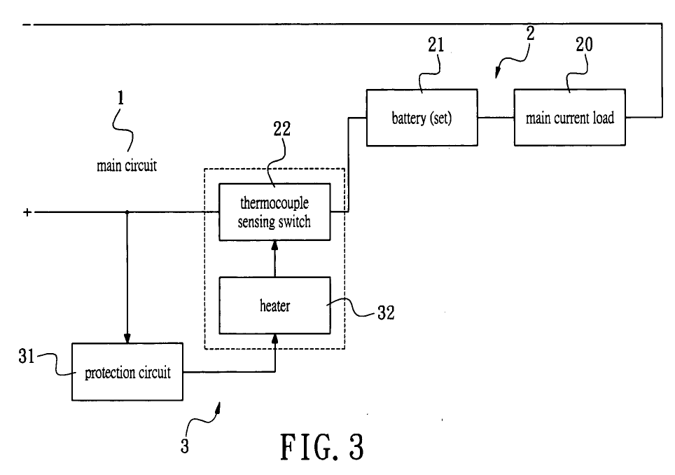

In another embodiment, the heater 32, as shown in FIG. 3, is a thermal resistor, and is combined with the thermocouple sensing switch 22 of the first protection loop 2 to directly heat the thermocouple sensing switch 22. The heater 32 is connected to the semiconductor switch 34 of the second protection loop 3 for control.

Two protection loops 2, 3 of the protection device for the rechargeable battery are connected to the main circuit 1, and the battery (set) 21 and the main current load 20, respectively. For normal charging and discharging currents (which are between 30˜40 amps), the first protection loop 2 and the second protection loop 3 are both turned off, so that the platinum sheet contacts 221, 222 of the thermocouple sensing switch 22 of the first protection loop 2 are conducted, as shown in FIG. 4. The protection circuit 31 of the second protection loop 3 also detects no over-charged or over-discharged condition, and does not output a control signal to turn on the semiconductor switch 34 and the thermocouple sensing switch 22 related to the heater 32.

When the large amperage power source battery (set) 21 generates high temperatures due to large currents, or suffers high environmental temperatures, the thermocouple sensing switch 22 connected to the main circuit 1 senses the excessive current or the high environmental temperature, and the platinum sheet contacts 221, 222 of the thermocouple sensing switch 22 will deform and automatically, triggering the thermocouple sensing switch 22, to protect the battery (set) 1, as shown in FIG. 5. When the excessive current or the high environmental temperature ends, the platinum sheet contacts 221, 222 of the thermocouple sensing switch 22 automatically return back to their original shapes, and once again conduct with each other, as shown in FIG. 4.

If the battery (set) 21 is in an over-charged or over-discharged condition, the circuit unit 33 of the protection circuit 31 of the second protection loop 3 detects this over-charged or over-discharged condition by comparing the voltage of the battery (set) 21 and generates an activaction signal to turn on the semiconductor switch 34. Then, the semiconductor switch 34 turns on the series heater 32 to heat the thermocouple sensing switch 22 connected to the main circuit 1 until a predetermined threshold temperature of the platinum sheet contacts 221, 222 of the thermocouple sensing switch 22 is reached. The platinum sheet contacts 221, 222 of the thermocouple sensing switch 22 will deform and automatically trigger to protect the battery (set) 21, as shown in FIG. 5. When the excessive current or the high environmental temperature ends, the protection circuit 31 turns off the semiconductor switch 34 to turn off the heater 26, and so the platinum sheet contacts 221, 222 of the thermocouple sensing switch 22 automatically return back to their original shapes to conduct with each other, as shown in FIG. 4.

When the battery (set) 21 generates large currents into the main circuit 1, or enters into an over-charged or over-discharged state, the device of the present invention utilizes the two protection loops to perform the protection process. The semiconductor switch 34 for the protection procedure can be a small sized CMOS switch, which is characterized by a small size, a high resistance, a low cost, high operating sensitivities, and which is able to simplify the design of the protection circuit.

Additionally, while the device of the present invention is operating, if the battery is over-charged, when the CMOS switch 34 turns on the heater 32, part of the current is thereby depleted, lowering the over-charged current.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A protection device for a rechargeable battery connected between a main current source and a large amperage power source, comprising:
a first protection loop comprising:
a main current load and a battery (set) connected to a main circuit; and
a thermocouple sensing switch connected to the battery (set) and the main circuit;
a second protection loop comprising:
a protection circuit connected to the main circuit and checking voltage of the battery to output an activation signal; and
at least one heater connected to the protection circuit and used for heating the thermocouple sensing switch.

2. The protection device for a chargeable battery as claimed in claim 1, wherein the thermocouple sensing switch further comprises at least two corresponding platinum sheet contacts having one end connected to the main circuit and the other connected to the battery (set).

3. The protection device for a rechargeable battery as claimed in claim 1, wherein the protection circuit further comprises a circuit unit, the circuit unit connected to the main circuit, and a semiconductor switch connected to the circuit unit and the heater.

4. The protection device for a rechargeable battery as claimed in claim 3, wherein the semiconductor switch is a complementary metal oxide semiconductor (CMOS) switch.

5. The protection device for a chargeable battery as claimed in claim 3, wherein if the there is an over-charge current, when the CMOS switch turns on the heater, some current is depleted to lower the over-charged current.

6. The protection device for a rechargeable battery as claimed in claim 3, wherein the semiconductor switch is a small sized CMOS switch which provides the chargeable battery protection for 3C consumer electronic products.

7. The protection device for a chargeable battery as claimed in claim 1, wherein the heater is placed next to the thermocouple sensing switch.

8. The protection device for a chargeable battery as claimed in claim 1, wherein the heater is a thermal resistor for generating heat and is combined with the thermocouple sensing switch, and the heater is connected to the semiconductor switch of the protection circuit of the second protection loop for control.

9. A protection device for a chargeable battery, to the protection device connected between a main current source and a large amperage power source, comprising:
a main current load and a battery (set) connected to a main circuit;
a thermocouple sensing switch connected to the main circuit and the battery (set);
a heater combined with the thermocouple sensing switch;
a protection circuit comprising:
a circuit unit connected to the main circuit and checking voltage of the battery to output an activation signal; and
a semiconductor switch connected to the circuit unit and to control the heater.

10. The protection device for a rechargeable battery as claimed in claim 9, wherein the heater is a thermal resistor for generating heat.
